(19) United States
(12) Patent Application Publication
(10) Pub. No.: US 2016/0014711 A1
(43) Pub. Date: Jan. 14, 2016

(54) ROUND TRIP TIME (RTT) DETERMINATION

(71) Applicant: QUALCOMM Incorporated, San Diego, CA (US)

(72) Inventor: Carlos Horacio Aldana, Mountain View, CA (US)

(21) Appl. No.: 14/796,576

(22) Filed: Jul. 10, 2015

Related U.S. Application Data
(60) Provisional application No. 62/024,392, filed on Jul. 14, 2014.

(51) Int. Cl. H04W 56/00; H04L 12/26

(52) U.S. Cl. CPC H04W 56/009; H04L 43/106; H04L 43/0864

(57) ABSTRACT

Techniques disclosed can help mitigate errors due to clock drift in the determination of round trip time (RTT) from a message exchange between two mobile stations. The techniques involve reducing the time (and, therefore, the drift) over which RTT is computed. Such techniques can be used with clock-synchronizing and/or other methods for reducing RTT errors to provide RTT calculations far more accurate than traditional methods.

### CROSS-REFERENCE TO RELATED APPLICATIONS

This application claims the benefit of U.S. Provisional Patent Application Ser. No. 62/024,392, entitled “ROBUST RTT TO CLOCK FREQUENCY DRIFT,” filed on Jul. 14, 2014, which is assigned to the assignee hereof and incorporated herein by reference for all purposes.

### BACKGROUND

A mobile station, or STA, can include at least one local clock on which the STA bases its communication and data processing. However, it is usually not possible to precisely synchronize the local clocks among the several STAs, and therefore, each local clock can have its own error, or clock drift. In positioning- or location-based applications using an 802.11 standard, determination of round trip time (RTT) for pre-specified messages or dialogs between two STAs, for example, can be used to provide an indication of distance between the two STAs. In a conventional method of RTT determination, when a transmitting STA is communicating with a receiving STA, the error (e.g., due to drift) in the transmitting STA's local clock gets compounded with the error in the receiving STA's local clock. Thus, the RTT determination and corresponding computation of distance between the two STAs is imprecise and highly error prone.

### SUMMARY

Techniques disclosed herein can help mitigate errors due to clock drift in the determination of RTT from a message exchange between two wireless transceivers. The techniques involve reducing the time (and, therefore, the drift) over which RTT is computed. Such techniques can be used with clock-synchronizing and/or other methods for reducing RTT errors to provide RTT calculations far more accurate than traditional methods.

An example method of calculating round trip time (RTT) from a first wireless device to a second wireless device, according to the disclosure, comprises sending, with the first wireless device, a first message, determining a first timestamp, indicative of an end of a period of time over which the first wireless device sent the first message, and receiving, with the first wireless device, a second message sent by the second wireless device in response to the first message. The method further comprises determining, with the first wireless device, a second timestamp, indicative of an end of a period of time over which the second wireless device received the first message, and a third timestamp, indicative of a beginning of a period of time over which the second wireless device sent the second message. The method also comprises determining a fourth timestamp, indicative of a beginning of a period of time over which the first wireless device received the second message, and determining the RTT from the first wireless device to the second wireless device, wherein determining the RTT is based, at least in part, on the first timestamp, the second timestamp, the third timestamp and the fourth timestamp.

The method can further comprise one or more of the following features. Determining the second timestamp and the third timestamp may comprise extracting the second timestamp and the third timestamp from the second message. Determining the second timestamp and the third timestamp may comprise extracting the second timestamp and the third timestamp from a third message, the third message received by the first wireless device and sent by the second wireless device in response to the first message. The method may further comprise receiving the third message in at least two parts, wherein the second timestamp is in one part of the third message and the third timestamp is in another part of the third message. The method may further comprise substantially synchronizing a clock of the first wireless device and a clock of the second wireless device. Sending the first message may be in response to a message sent from the second wireless device and received by the first wireless device.

An example wireless device, according to the disclosure, comprises a memory, a wireless communication interface configured to wirelessly send a first message to a second wireless device, and wirelessly receive a second message sent by the second wireless device in response to the first message, and a processing unit communicatively coupled with the memory and the wireless communication interface. The processing unit is configured to determine a first timestamp, indicative of an end of a period of time over which the wireless device sent the first message, determine a second timestamp, indicative of an end of a period of time over which the second wireless device received the first message, determine a third timestamp, indicative of a beginning of a period of time over which the second wireless device sent the second message, and determine a fourth timestamp, indicative of a beginning of a period of time over which the wireless device received the second message. The processing unit is further configured to determine round trip time (RTT) from the wireless device to the second wireless device, wherein determining the RTT is based, at least in part, on the first timestamp, the second timestamp, the third timestamp and the fourth timestamp.

The wireless device can include one or more of the following features. The processing unit may be configured to determine the second timestamp and the third timestamp by extracting the second timestamp and the third timestamp from the second message. The processing unit may be configured to determine the second timestamp and the third timestamp by extracting the second timestamp and the third timestamp from a third message, the third message received by the wireless device and sent by the second wireless device in response to the first message. The wireless device may further comprise a local clock, wherein the processing unit is further configured to substantially synchronize the local clock to a clock of the second wireless device. The processing unit may be configured to substantially synchronize the clock of the wireless device to the clock of the second wireless device prior to determining the RTT. The processing unit may be configured to send the first message to the second wireless device in response to receiving an earlier message from the second wireless device.

Another example method of calculating round trip time (RTT) from a first wireless device to a second wireless device, according to the description, comprises receiving, with the second wireless device from the first wireless device, a first message, sending, with the second wireless device to the first wireless device, a second message in response to the first message, and determining a first timestamp, indicative of an end of a period of time over which the second wireless device received the first message and a second timestamp, indicative of a beginning of a period of time over which the second wireless device sent the second message. The method further comprises communicating the first timestamp and the second timestamp to the first wireless device.

The method can include one or more of the following features. Communicating the first timestamp and the second timestamp to the first wireless device may comprise including the first timestamp and the second timestamp in the second message. Communicating the first timestamp and the second timestamp to the first wireless device may comprise including the first timestamp and the second timestamp in a third message, the third message sent to the first wireless device by the second wireless device in response to the first message. The method may include sending, with the second wireless device, the third message in at least two parts, wherein the first timestamp is in one part of the third message and the second timestamp is in another part of the third message.

Another example wireless device, according to the disclosure, comprises a memory, a wireless communication interface configured to wirelessly receive a first message from another wireless device and wirelessly send, to the other wireless device, a second message in response to the first message, and a processing unit communicatively coupled with the wireless communication interface. The processing unit is configured to determine a first timestamp, indicative of an end of a period of time over which the wireless device received the first message, determine a second timestamp, indicative of a beginning of a period of time over which the wireless device sent the second message, and communicate, via the wireless communication interface, the first timestamp and the second timestamp to the other wireless device.

The wireless device can include one or more of the following features. The processing unit may be configured to communicate the first timestamp and the second timestamp to the other wireless device by including the first timestamp and the second timestamp in the second message. The processing unit may be configured to communicate the first timestamp and the second timestamp to the other wireless device by including the first timestamp and the second timestamp in a third message, the third message sent, via the wireless communication interface, to the other wireless device in response to the first message. The processing unit may be further configured to send the third message in at least two parts, wherein the first timestamp is in one part of the third message and the second timestamp is in another part of the third message.

### BRIEF DESCRIPTION OF THE DRAWINGS

An understanding of the nature and advantages of various embodiments may be realized by reference to the following figures.

FIG. 1A is a simplified illustration of a wireless communication system, according to one embodiment.

FIG. 1B is a drawing that helps illustrate a basic setup in which RTT may be used, according to one embodiment.

FIG. 2 is a simplified timing diagram that illustrates a technique for computation of RTT between a sending STA (STA1) and a receiving STA (STA2).

FIG. 3 is a simplified timing diagram that illustrates a new technique for computation of RTT, according to one embodiment.

FIG. 4 is a call flow diagram that illustrates the interaction between first and second wireless devices in a process for computing RTT using the new technique of FIG. 3, according to one embodiment.

FIG. 5 is a flow diagram illustrating a method of calculating RTT from the first wireless device to a second wireless device.

FIG. 6 is a flow diagram illustrating method of facilitating the calculation of RTT, according to one embodiment.

FIG. 7 is a block diagram an embodiment of a wireless device.

FIG. 8 is a block diagram an embodiment of a computing device.

### DETAILED DESCRIPTION

The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

Wireless communication systems may comprise wireless devices and access points (APs), which allow the wireless devices to connect to a wired or wireless network using one or more wireless standards. Some wireless communication systems can allow wireless devices to be configured as mobile stations (STAs) that can communicate between one another or through the APs. Standards such as IEEE 802.11ac, 802.11ad, 802.11v, 802.11mc, etc. are commonly used for such communications. These standards can include error specifications to ensure quality of communication.

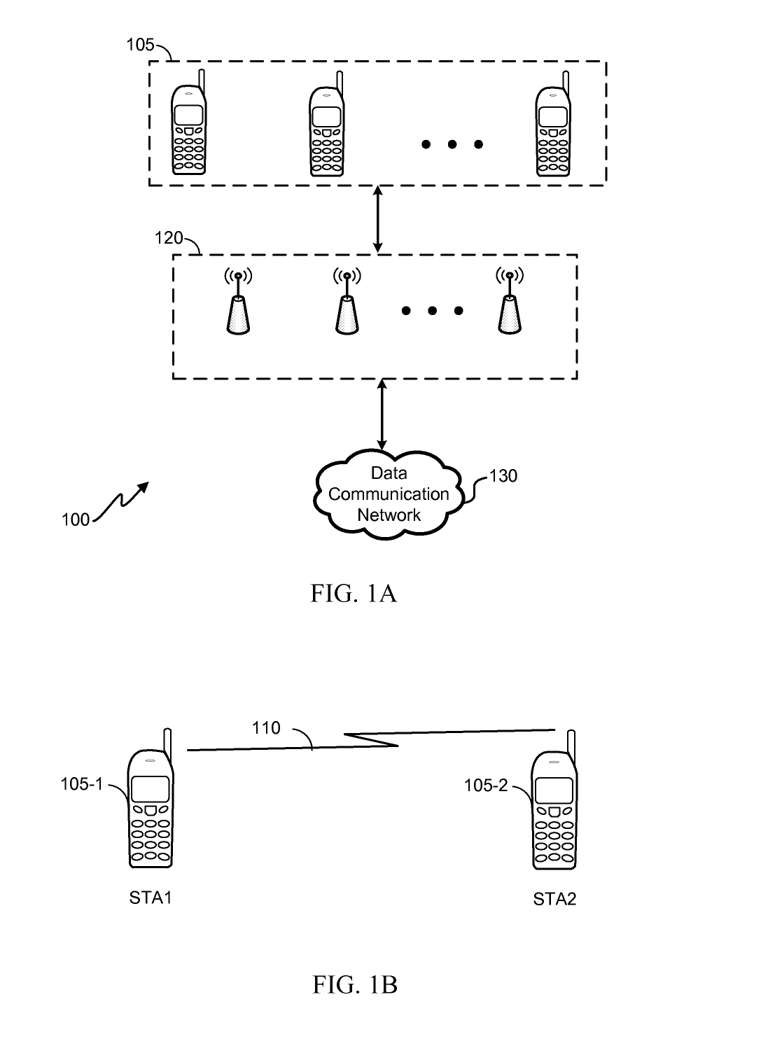

FIG. 1A is a simplified illustration of a wireless communication system 100, according to one embodiment. The wireless communication system 100 can include one or more STA(s) 105, AP(s) 120, and a data communication network 130. It should be noted that FIG. 1A provides only a generalized illustration of various components, any or all of which may be utilized as appropriate. Furthermore, components may be rearranged, combined, separated, substituted, and/or omitted, depending on desired functionality. For example, although only a few STAs 105 and APs are illustrated in the wireless communication system 100 illustrated in FIG. 1A, embodiments may include a smaller or larger number of either or both STAs and/or APs. For instance, embodiments may include dozens, hundreds, thousands, or more of either or both STAs and/or APs. In addition, STA(s) 105 and/or AP(s) 120 may be connected with one or more additional networks, such as cellular carrier network, a satellite positioning network, and the like which can have a variety of components (e.g., servers, satellites, base stations, etc.), which are not illustrated in FIG. 1A. A person of ordinary skill in the art will recognize many modifications to the embodiment illustrated.

A wireless device or STA, as described herein, may comprise a system, subscriber unit, subscriber station, mobile station, mobile, remote station, remote terminal, mobile device, user terminal, terminal, wireless communication device, user agent, user device, or user equipment (UE). An STA can be a cellular telephone, a cordless telephone, a session initiation protocol (SIP) phone, a wireless local loop (WLL) station, a personal digital assistant (PDA), a handheld device having wireless connection capability, computing device, or other processing device connected to a wireless modem.

It is further noted that, although techniques described herein refer to mitigating clock drift between two STAs, embodiments are not so limited. Techniques described herein may apply more generally to two wireless transceivers, including APs and/or other wireless devices.

As mentioned earlier, STA(s) 105 can communicate with AP(s) 120, which can enable the STA(s) 105 to a data communication network 130. Communication to and from the STA(s) 105 may thus also be implemented, in some embodiments, using various wireless communication standards and/or protocols, which may be determined by the data communication network 130. Some embodiments can include, for example, one or more of the IEEE 802.11 family of standards, as discussed above. The data communication network 130 may comprise one or more of a variety of networks, including local networks such as a local area network (LAN) or a personal area network (PAN), a wide area network (WAN) such as the Internet, and/or any of a variety of public and/or private communication networks. Moreover, networking technologies can include switching and/or packetized networks utilizing optical, radio frequency (RF), wired, satellite, and/or other technologies.

The wireless communication system 100 may comprise provide positioning capabilities to calculate and/or estimate the location of one or more STAs 105. Such capabilities can include a satellite positioning system (SPS), such as the Global Positioning System (GPS), and/or triangulation and/or trilateration provided by stationary components (such as the AP(s) 120). Additionally or alternatively, where there is a plurality of STAs 105 in a wireless communication system 100, the STAs 105 may be configured to provide positioning capabilities based on their determined distance from one another.

An STA 105 can include at least one local clock, on which the STA 105 bases its communication and data processing. However, it is usually not possible to precisely synchronize the local clocks among the several STAs, and therefore, each local clock can have its own error or clock drift. In positioning or location based applications using an 802.11 standard, determination of round trip time (RTT) for pre-specified messages or dialogs between two STAs, for example, can be used to provide an indication of distance between the two STAs. In a conventional method of RTT determination, when a transmitting STA, for example, is communicating with a receiving STA, the error (e.g., due to drift) in the transmitting STA's local clock gets compounded with the error in the receiving STA's local clock. Thus, the RTT determination and corresponding computation of distance between the two STAs is imprecise and highly error prone. As detailed below, embodiments can provide for RTT determination in which errors due to drift are mitigated.

In general, embodiments described herein may pertain to wireless communications for devices utilizing a wireless communication system 100, such as a wireless local area network (WLAN), according to various IEEE 802.11 messaging standards. That said, some embodiments may utilize standards other than the IEEE 802.11 family of standards. Embodiments may improve on acquiring a position of an STA using wireless APs, for example, by reducing errors contributed by clock drift in the STAs towards calculation of RTTs. Rather than relying on satellite signals or assistance data from terrestrial base stations transmitting satellite geo-positioning data, STAs may acquire their geographic locations using wireless APs. The APs may transmit and receive wireless signals following various IEEE 802.11 standards, such as 802.11g, 802.11n, 802.11ac, 802.11ad, 802.11v, etc. In some embodiments, STAs may comply with 802.11ac, 802.11v, and/or 802.11mc standards while transmitting or receiving signals from multiple antennas. Some embodiments may sample timing signals in 0.1 nanosecond (ns) increments while some embodiments may sample signals in time increments of less than 10 ns, e.g. 1.5 ns, 2 ns, 0.1 ns, etc., while still complying with the standards. Embodiments may implement time of departure (TOD) and time of arrival (TOA) measurements from 802.11 standards based on definitions that account for transmitted signals from multiple antennas. In some embodiments, the time difference between the TOA and TOD may be transmitted, rather than transmitting the TOA and TOD. In some embodiments, both receiving and sending STAs may transmit information sufficient to compute TOD and TOA measurements. In some embodiments, these new messages may be codified in revised 802.11 standards. The APs may transmit and receive timing measurements, such as TOA and TOD measurements, to and from the STAs. When an STA obtains timing measurements from three or more APs, along with geographical positioning information from the APs, the STA may be able to determine its location by performing techniques similar to GPS positioning, e.g. trilateration and the like, using the multiple timing measurements. In some cases (e.g., particularly when at least one of the STAs is stationary) the STAs may transmit and receive timing measurements between one another in order to obtain the RTT and the distance between one another.

FIG. 1B is a drawing that helps illustrate a basic setup in which RTT may be used, according to one embodiment. Here, two STAs (STA1 105-1 and STA2 105-2) can communicate with each other using wireless communication signals 110. The STAs 105 may be part of a larger system, such as the wireless communication system 100 illustrated in FIG. 1A. To obtain the RTT and estimated distance from one STA to the other, the STAs 105 may engage in an exchange of fine timing measurement frame and acknowledgement, as described below.

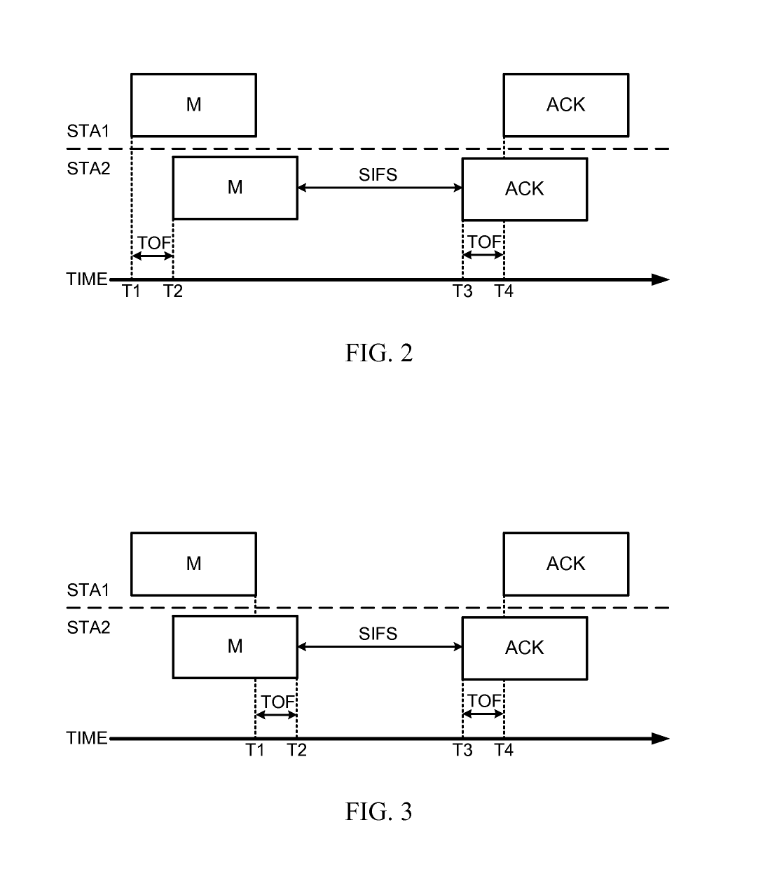

FIG. 2 is a simplified timing diagram that illustrates an existing technique for computation of RTT between a sending STA (STA1) and a receiving STA (STA2), which may be consistent for example, with specifications, diagrams, and guidelines found in some 802.11 standards. Here, STA1 and STA2 may correspond to STA1 105-1 and STA2 105-2 of FIG. 1B, respectively. In some embodiments and/or applicable standards, the timing diagram shown in FIG. 2 can follow a request from STA2 and acknowledgment from STA1. Here, STA1 transmits a fine timing measurement frame M. STA1 captures a first time (T1) at which the fine timing measurement frame M is transmitted. STA2 captures a second time (T2) at which the fine timing measurement frame M arrives at STA2. Additionally, STA2 captures a third time (T3) at which it transmits an acknowledgement message ACK. STA1 captures a fourth time (T4) at which the ACK arrives. The RTT can then be calculated as follows:

RTT=(T4−T1)−(T3−T2) (1)

However, each of STA1 and STA2 are likely to have clock drifts in their local clocks, which will degrade the precision of the RTT obtained as above.

To illustrate, assume that the clock drift of a local clock in STA1 has an error, measured as a variation in parts per million (ppm) from the expected frequency, of ppm1. The ppm value can be positive or negative, depending on how the clock drifts. Similarly, STA2 has a local clock drift of ppm2. With reference again to FIG. 2, the various timestamps T1, T2, T3, and T4 will be examined in further detail with the above assumptions. (As used herein, the term “timestamp” can include any value, flag, marker, and/or other indication of time.) As can be seen, T2 is equal to T1 plus the time of flight (TOF) (where TOF is half of RTT) of the fine timing measurement frame sent from STA1 to STA2. Or, in other words:

T2=T1+TOF (2)

The time T3 is obtained from adding the duration of the fine timing measurement frame M (the duration of which is also referred to herein as “M”) to the time it takes STA2 to respond to the message, also known as short inter frame spacing (SIFS). In other words:

T3=T2+M+SIFS (3)

The time T4 is similarly obtained, as T3 plus the TOF, for the ACK from STA2 to STA1. In mathematical terms:

T4=T3+TOF (4)

Since STA1 can vary with an error of ppm1, timestamps T4 and T1 computed at STA1 will be multiplied by a factor of (1+ppm1). Similarly, the times T3 and T2 computed at STA2 will be multiplied by a factor of (1+ppm2). With the above understanding, equation (1) above can be expressed in more detail as follows:

$$\begin{matrix}RTT = ( T 4 - T 1 ) - ( T 3 - T 2 ) \\ = ( T 3 + TOF - T 1 ) \times ( 1 + ppm 1 ) - ( M + SIFS ) \times ( 1 + ppm 2 ) \\ = ( 2 \times TOF + M + SIFS ) \times ( 1 + ppm 1 ) - ( M + SIFS ) \times ( 1 + ppm 2 ) \\ = 2 \times TOF \times ( 1 + ppm 1 ) + ( M + SIFS ) \times ( ppm 1 - ppm 2 )\end{matrix} \qquad ( 5 )$$

In a practical example, M can be 100 μs and SIFS can be 16 μs. Under current 802.11 specifications ppm1 and ppm2 can be up to 25 ppm. Thus, if STA1 and STA2 drift in different directions (e.g., −25 ppm and +25 ppm), the differential (ppm1−ppm2) can be as large as 50 ppm. This can result in an error of the RTT of 5.8 ns, which amounts to a position uncertainty of about 1.7 meters. In positioning applications, an error of such magnitude may be unacceptably large (particularly if STA1 and STA2 are close by).

One approach to solving this RTT error is for STA2 to synchronize (or substantially synchronize) its clock to the clock of STA1 (or, alternatively, synchronize (or substantially synchronize) the clock of STA1 to the clock of STA2). In such instances, (1+ppm2) can be substituted with (1+ppm1−residual_ppm) (where residual_ppm is due to a small difference in the clocks of STA1 and STA2, due to imperfect clock locking). Equation (5) above can then be updated as follows:

RTT=2×TOF×(1+ppm1)+(M+SIFS)×(residual_{—}ppm) (6)

If residual_ppm is on the order of 1 ppm, then the RTT error in the example above is reduced to 0.116 ns, which results in a position uncertainty of 0.03 m. This is an improvement over the techniques described above by a factor of 50.

Embodiments herein provide a new approach to reducing RTT error, which can be used as an alternative or in addition to the above described clock-synchronizing approach. As detailed below, when these approaches are used in conjunction, error reduction can be significantly larger than when either approach is used alone.

FIG. 3 is a simplified timing diagram that illustrates this new approach, according to one embodiment. As can be seen, the exchange of fine timing measurement frame M and acknowledgement measuring frame ACK is similar to the exchange shown in FIG. 2. Here, however, timestamps T1 and T2 are taken at the end of the fine timing measurement frame M, rather than at the beginning. Timestamps T3 and T4 can remain unchanged, at the beginning. In so doing, any error due to the drift that occurs in the clocks of STA1 and STA2 during the transmittal and receipt of M is removed from the RTT calculation. In other words, T3 is no longer T2+M+SIFS. Instead:

T3=T2+SIFS (7)

Following the sequence of equations provided above in respect to equation (5), RTT can be computed as follows:

$$\begin{matrix}RTT = ( T4 - T 1 ) - ( T 3 - T 2 ) \\ = ( T 3 + TOF - T 1 ) \times ( 1 + ppm 1 ) - ( SIFS ) \times ( 1 + ppm 2 ) \\ = ( 2 \times TOF + M + SIFS ) \times ( 1 + ppm 1 ) - ( SIFS ) \times ( 1 + ppm 2 ) \\ = 2 \times TOF \times ( 1 + ppm 1 ) + ( SIFS ) \times ( ppm 1 - ppm 2 )\end{matrix} \qquad ( 8 )$$

In values in the examples provided above, this new approach alone can provide an improvement of 166/16, or 7.25. Additionally, if this new approach is used in conjunction with the clock-synchronizing approach, the RTT error can be reduced to 16 ps, which results in a position uncertainty of 0.0048 m. This is an improvement over the traditional techniques described above by a factor of 363.

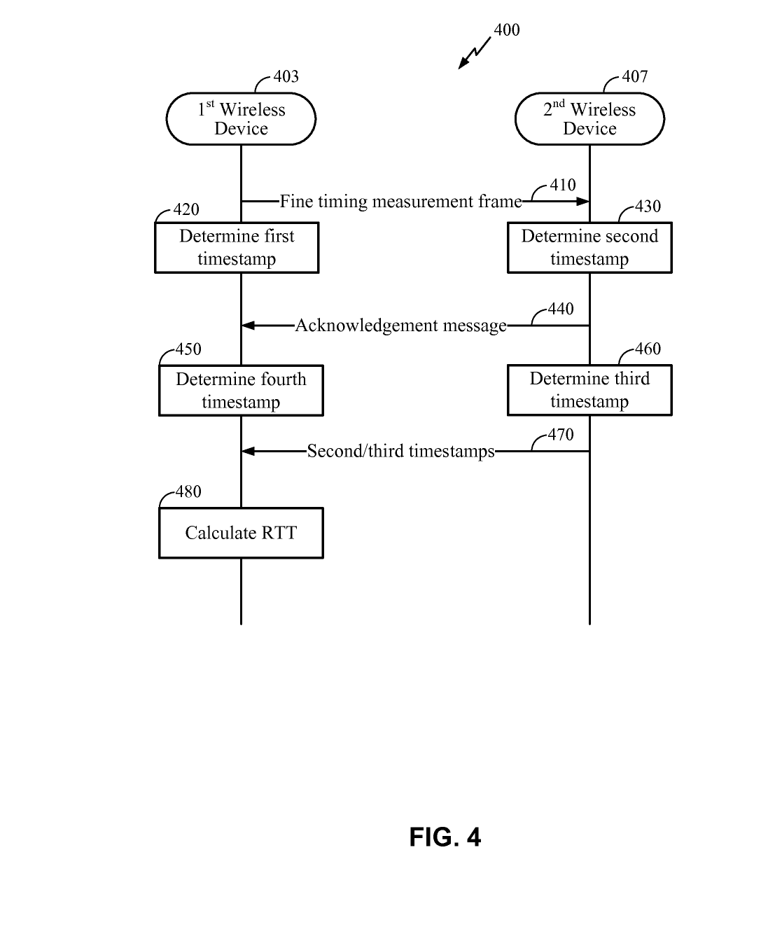

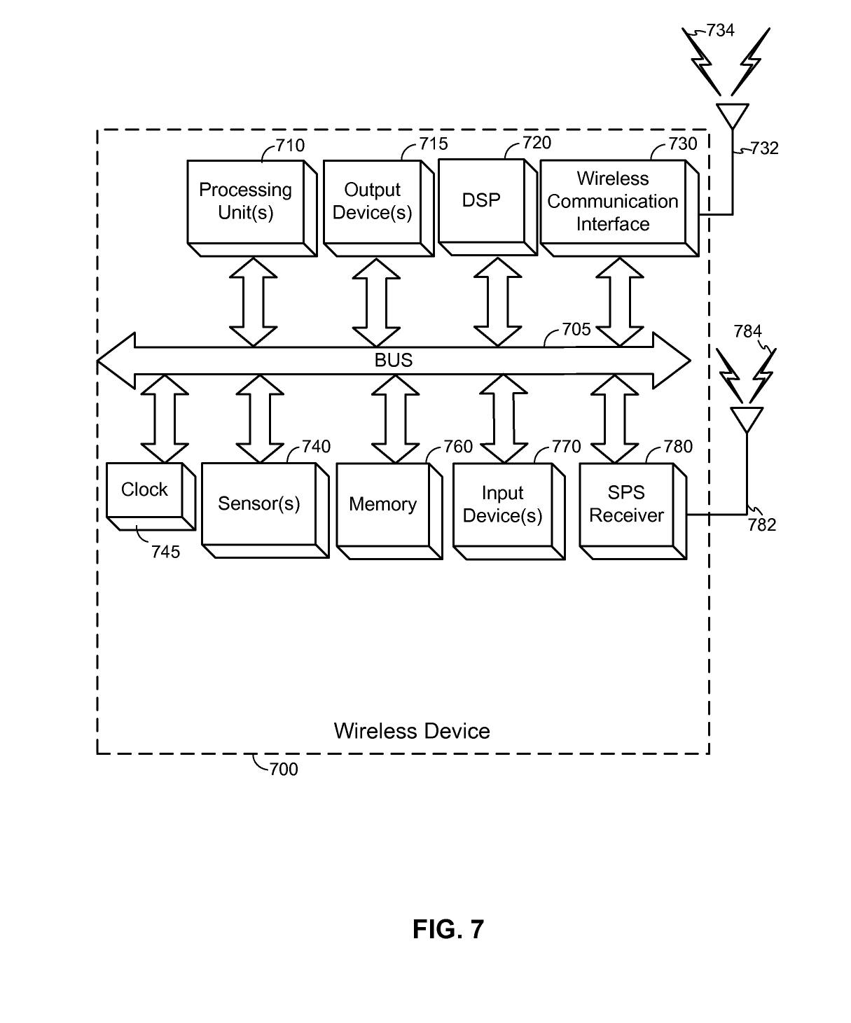

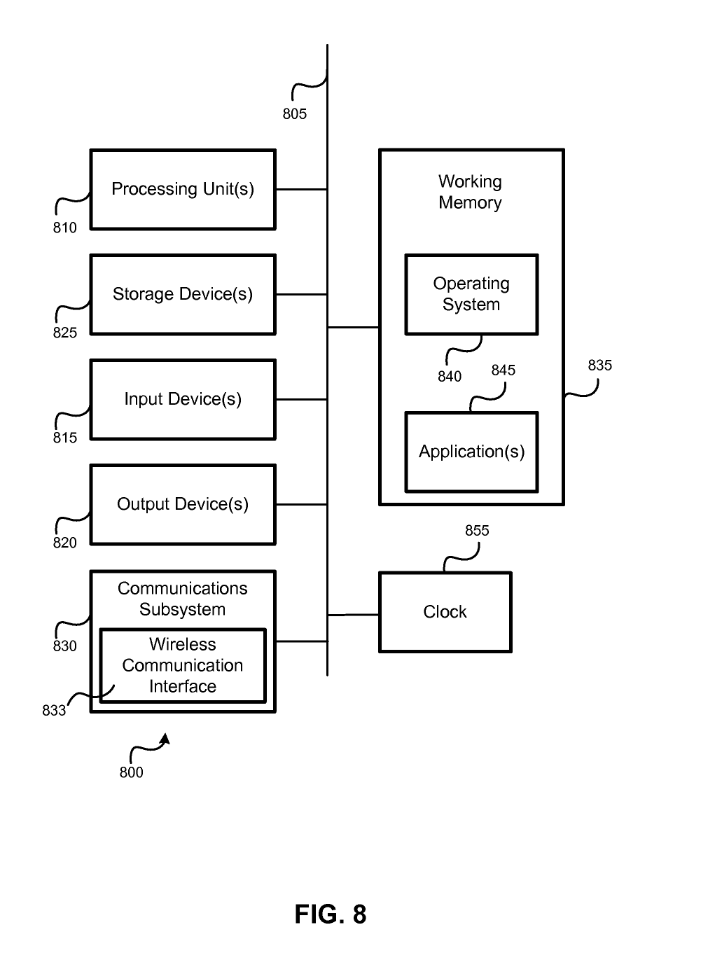

FIG. 4 is a call flow diagram that illustrates the interaction between a first wireless device 403 and a second wireless device 407 in a process for computing RTT using the technique illustrated of FIG. 3, according to one embodiment. Means for performing the functionality of the blocks may include one or more hardware and/or software components, such as those of a wireless device as shown in FIG. 7 or a computing device shown in FIG. 8. A person of ordinary skill in the art will recognize many variations.

At block 410, the first wireless device 403 sends a fine timing measurement frame (e.g., M of FIG. 3), or, more generically, a first message, to the second wireless device 407. The first and second wireless devices can then determine timestamps associated with the fine timing measurement frame. Particularly, at block 420, the first wireless device 403 determines a first timestamp (e.g., T1 of FIG. 3), and, at block 430, the second wireless device 407 determines a second timestamp (e.g., T2 of FIG. 3).

At block 440, the second wireless device 407 sends an acknowledgment message (e.g., ACK of FIG. 3), or, more generically, a second message, to the first wireless device 403, in response to receiving the fine timing measurement frame at block 410. The first and second wireless devices can then determine timestamps associated with the acknowledgement message. Particularly, at block 460, the second wireless device 407 determines a third timestamp (e.g., T3 of FIG. 3), and, at block 450, the first wireless device 403 determines a fourth timestamp (e.g., T4 of FIG. 3).

At block 480, the first wireless device 403 then calculates RTT between the first wireless device 403 and the second wireless device 480 using the first, second, third, and fourth timestamps.

Some embodiments may vary from the functionality illustrated in FIG. 4, depending on desired functionality. For example, the order of determining timestamps and sending messages may be altered. In some embodiments, the second and/or third timestamp may be included in the acknowledgement message at block 440, where possible. In some embodiments, the third message may be sent in two or more parts, where the second timestamp is sent in one part of the third message, and the third timestamp is sent in another part of the third message. A person of ordinary skill in the art will recognize many variations on the embodiment illustrated.

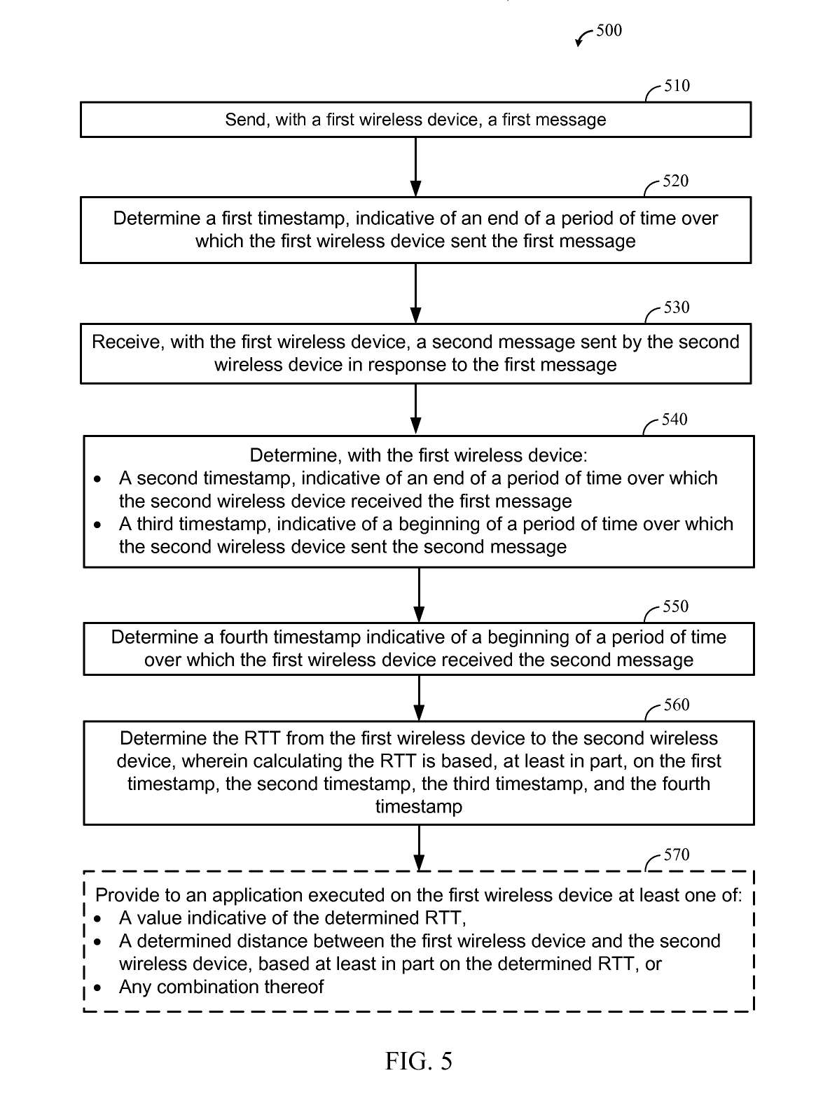

It will be appreciated that embodiments include various methods for performing the new approach disclosed above with regard to FIGS. 3 and 4. For example, as illustrated in FIG. 5, an embodiment can include a method 500 of calculating RTT from the first wireless device (e.g., STA1 of FIG. 3 or the first wireless device of FIG. 4) to a second wireless device (e.g., STA2). The method can be executed by, for example, the first wireless device. A person of ordinary skill in the art will recognize that alternative embodiments may include methods in which the components shown in FIG. 5 are rearranged, omitted, merged, separated, and/or otherwise altered. Means for performing one or more of the components shown in FIG. 5 can include one or more components of a wireless device, such as the wireless device shown in FIG. 7 or the computing device shown in FIG. 8.

At block 510, a first message is sent with the first wireless device. In some embodiments, as illustrated in FIG. 3, the first message may include a fine timing measurement frame (e.g., frame M from STA1). In some embodiments, there may be some initial coordination between a first and second wireless device. For example, the first and/or second wireless device may transmit a separate message beforehand to coordinate the exchange of messages illustrated in FIGS. 3 and 4 (e.g., an indication and acknowledgement of the imminent exchange of messages as shown in FIG. 3). Means for performing the functionality described in block 510 can include, for example, the processing unit(s) 710, wireless communication interface 730, bus 705, and memory 760 of the wireless device 700 illustrated in FIG. 7, or the processing unit(s) 810, wireless communication interface 833, bus 805, storage device(s) 825, and working memory 835 of the computing device 800 illustrated in FIG. 8.

The functionality of block 520 involves determining a first timestamp, indicative of the end of a period of time over which the first wireless device sent the first message, as illustrated in FIGS. 3 and 4. Means for performing the functionality described in block 520 can include, for example, the processing unit(s) 710, bus 705, and memory 760 of the wireless device 700 illustrated in FIG. 7, or the processing unit(s) 810, bus 805, storage device(s) 825, and working memory 835 of the computing device 800 illustrated in FIG. 8.

At block 530, the first wireless device receives a second message sent by the second wireless device in response to the first message. In some embodiments, as illustrated in FIG. 3, the second message may include an acknowledgement frame (e.g., ACK, sent by STA2), transmitted by the second device in response the second wireless device's receipt of the first message. Means for performing the functionality described in block 530 can include, for example, the processing unit(s) 710, wireless communication interface 730, bus 705, and memory 760 of the wireless device 700 illustrated in FIG. 7, or the processing unit(s) 810, wireless communication interface 833, bus 805, storage device(s) 825, and working memory 835 of the computing device 800 illustrated in FIG. 8.

At block 540, the first wireless device determines a second timestamp, indicative of the end of a period of time over which the second wireless device receive the first message (e.g., T2 of FIG. 3) and a third timestamp, indicative of the beginning of a period of time over which the second wireless device sent the second message (e.g., T3 of FIG. 3). In some embodiments, determining the second timestamp and the third timestamp may comprise extracting these timestamps from the second message sent from the second wireless device. Some embodiments, such as the embodiment illustrated in FIG. 4, may include these timestamps in a third message to the first wireless device (or another wireless device) for calculation of the RTT. In such embodiments, determining the second timestamp and the third timestamp may comprise extracting, by the first wireless device. In some embodiments, the third message may be sent and received in two parts, where the second timestamp is in one part of the third messages, and the third timestamp is in another part of the third message. Some embodiments may not involve the second wireless device transmitting these values if the second wireless device calculates the RTT (in such a case, the first wireless device could provide the second wireless device with values for T1 and T4, for example). The content of the messages, transmission of timestamp values, and/or other aspects of the functionality of block 520 may be governed by applicable standards. Means for performing the functionality described in block 540 can include, for example, the processing unit(s) 710, wireless communication interface 730, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

The functionality of block 550 involves determining a fourth timestamp, indicative of the end of a period of time over which the first wireless device received the second message (e.g., T4 of FIG. 3), as illustrated in FIG. 3. Means for performing the functionality described in block 550 can include, for example, the processing unit(s) 710, bus 705, and memory 760 of the wireless device 700 illustrated in FIG. 7, or the processing unit(s) 810, bus 805, storage device(s) 825, and working memory 835 of the computing device 800 illustrated in FIG. 8.

At block 560, the RTT from the first wireless device to the second wireless device is determined, based on the first timestamp, the second timestamp, the third timestamp, and the fourth timestamp. Depending on the desired functionality, RTT can be determined by the first wireless device, the second wireless device, or a third device to which the first and second timestamps are communicated. The timing values, message content, and/or other aspects of the method 500 of FIG. 5 may be governed and/or dictated based on an applicable standard (e.g., IEEE 802.11mc). Means for performing the functionality described in block 560 can include, for example, the processing unit(s) 710, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

Optionally, at block 570, an application executed on the first wireless device is provided at least one of a value indicative of the determined RTT, a determined distance between the first wireless device and the second wireless device (based at least in part on the determined RTT), or any combination thereof. As indicated above, the determination of the RTT at block 560 may be performed by hardware, firmware, or other means of the first wireless device (as depicted in FIGS. 7 and 8). As such, the determination of the RTT using the techniques disclosed herein can be a feature of lower-level functionality the first wireless device made available to an application executed by the first wireless device. The application can include any application that may utilize the value indicative of the determined RTT and/or the determined distance between the first wireless device and the second wireless device, such as a mapping application, navigation application, or the like. (Alternatively, the determination of RTT may be made by one application and provided to another.) The value indicative of the determined RTT and/or the determined distance between the first wireless device and the second wireless device may be utilized by an application for positioning and/or other functions provided by the application. Additionally or alternatively, some embodiments may send the value indicative of the determined RTT and/or the determined distance between the first wireless device and the second wireless device to another device (e.g., a server) for location determination and/or other calculations. In some embodiments, the value indicative of the determined RTT may be the RTT itself, which may be provided, in some embodiments, as one of several RTT values determined by the first wireless device. Means for performing the functionality described in block 570 can include, for example, the processing unit(s) 710, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

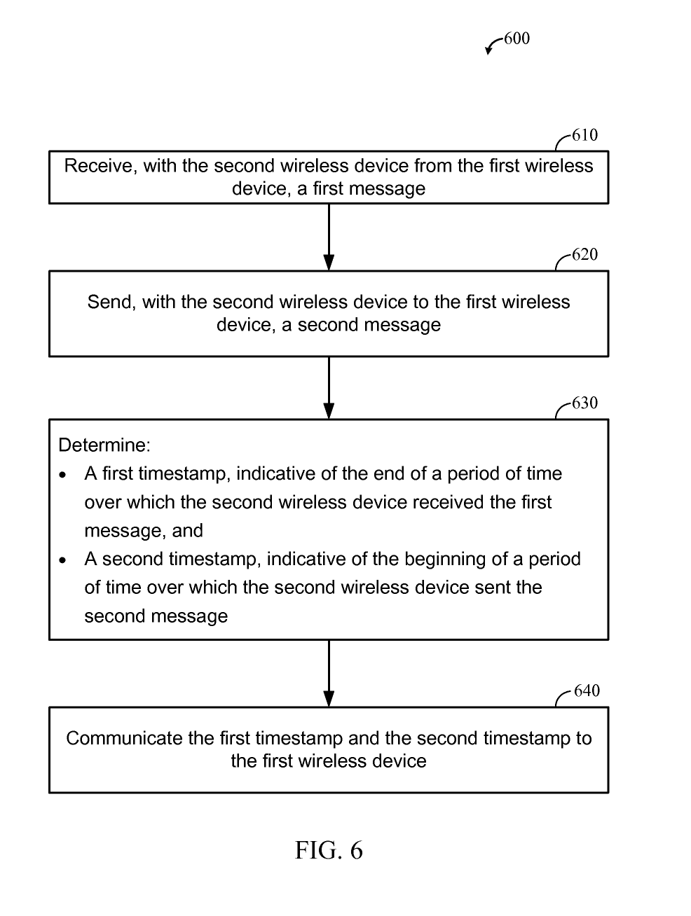

FIG. 6 is a flow diagram that illustrates an embodiment of a method 600 of calculating of RTT from the first wireless device (e.g., STA1) to a second wireless device (e.g., STA2), from the perspective of the second device (e.g., STA2 of FIG. 3 or the second wireless device of FIG. 4). Again, a person of ordinary skill in the art will recognize that alternative embodiments may include methods in which the components shown in FIG. 6 are rearranged, omitted, merged, separated, and/or otherwise altered. Means for performing one or more of the components shown in FIG. 7 can include one or more components of a wireless device, such as the wireless device shown in FIG. 7, or the processing unit(s) 810, bus 805, wireless communication interface 833, storage device(s) 825, and working memory 835 of the computing device 800 illustrated in FIG. 8.

At block 610, the second wireless device receives a first message from the first wireless device. As indicated previously, the first message may be sent from the first wireless device in response to initial coordination between a first and second wireless device (e.g., a request and acknowledgement to exchange of messages as shown in FIG. 3). Means for performing the functionality described in block 610 can include, for example, the processing unit(s) 710, wireless communication interface 730, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

At block 620, the second wireless device sends a second message to the first wireless device. As previously discussed, in some embodiments, as illustrated in FIG. 3, the second message may include an acknowledgement frame (e.g., ACK, sent by STA2), transmitted by the second device in response the second wireless device's receipt of the first message. In some embodiments, the second message may include timestamps (e.g., T2 and T3 of FIG. 3) embedded therein, which may be extracted by the first device. The content of the messages, transmission of timestamp values, and/or other aspects of the functionality of block 620 may be governed by applicable standards. Means for performing the functionality described in block 620 can include, for example, the processing unit(s) 710, wireless communication interface 730, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

At block 630, first and second timestamps are determined, where the first timestamp (e.g., T2 in FIG. 3) is indicative of the end of a period of time over which the second wireless device received the first message and the second timestamp (e.g., T3 in FIG. 3) is indicative of the beginning of a period of time over which the second wireless device sent the second message. In some embodiments, the determination of these timestamps in block 630 can be made by the second wireless device and completed before the sending of the second message in block 620 is complete, thereby enabling one or both of the timestamps to be embedded in the second message. In some embodiments, the first timestamp, the second timestamp, or both, are determined prior to the second wireless device sending of the second message. In some embodiments, the second wireless device can communicate the first and/or second timestamps to the first wireless device in the second message (as previously indicated) and/or a separate message. Means for performing the functionality described in block 630 can include, for example, the processing unit(s) 710, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8. The timing values, message content, and/or other aspects of the method 600 of FIG. 6 may be governed and/or dictated based on an applicable standard (e.g., IEEE 802.11mc).

At block 640, the first timestamp and the second timestamp are communicated to the first wireless device. As indicated elsewhere herein, communicating the first and/or second timestamps may comprise including the first and/or second timestamps in the second message. Alternatively, as shown in FIG. 4, communicating the first and/or second timestamps may comprise including the first and/or second timestamps in a third message, where the third message is sent to the first wireless device by the second wireless device in response to the first message. In some embodiments, the third message may be sent in two parts, where the first timestamp is sent in one part and the second time stamp is sent in another part. Means for performing the functionality described in block 640 can include, for example, the processing unit(s) 710, bus 705, and memory 760 of the wireless device 700 illustrated in FIG. 7, or the processing unit(s) 810, bus 805, wireless communication interface 833, storage device(s) 825, and working memory 835 of the computing device 800 illustrated in FIG. 8.

In some embodiments, the second wireless device may further receive a third timestamp (e.g., T1 from FIG. 3) indicative of the end of a period of time over which the first wireless device sent the first message, and a fourth timestamp (e.g., T4 from FIG. 3) indicative of the beginning of a period of time over which the first wireless device received the second message, either or both of which may be sent from the first wireless device. Depending on the desired functionality, the second wireless device can then calculate RTT based on first, second, third, and fourth timestamps. The second wireless device may further calculate a distance between the first and second wireless devices based on the calculated RTT. In some embodiments, calculating the RTT and/or the distance between the first and second wireless devices may be performed as an alternative to the functionality of block 640.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

FIG. 7 illustrates an embodiment of a wireless device 700, which can be utilized as described herein above. For example, the wireless device 700 can be used as a wireless device and/or a STA 105 described in relation to FIGS. 1-5. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations. In some embodiments, for example, the wireless device 700 can be a cellular telephone or other mobile electronic device. In some embodiments, the wireless device may be a stationary device, such as an AP. As such, as previously indicated, components may vary from embodiment to embodiment.

The wireless device 700 is shown comprising hardware elements that can be electrically coupled via a bus 705 (or may otherwise be in communication, as appropriate). The hardware elements may include a processing unit(s) 710 which can include without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein, such as those described in relation to FIGS. 5 and 6. As shown in FIG. 7, some embodiments may have a separate DSP 720, depending on desired functionality. The wireless device 700 also can include one or more input devices 770, which can include without limitation a touch screen, a touch pad, microphone, button(s), dial(s), switch(es), and/or the like; and one or more output devices 715, which can include without limitation a display, light emitting diode (LED), speakers, and/or the like.

The wireless device 700 may include a clock 745 on the bus 705, which can generate a signal to synchronize the various components on the bus 705. As indicated previously, the clock may be synchronized (or substantially synchronized) with corresponding clocks on other wireless devices to help increase the accuracy of RTT measurements. The clock 745 may be driven by the wireless communication interface 730, which may be used to synchronize the clock 745 of the wireless device 700 to one or more other devices.

The wireless device 700 might also include a wireless communication interface 730, which can include without limitation a modem, a network card, an infrared communication device, a wireless communication device, and/or a chipset (such as a Bluetooth™ device, an IEEE 802.11 device (utilizing one or more of the 802.11 standards, such as those described herein), an IEEE 802.15.4 device, a WiFi device, a WiMax device, cellular communication facilities, etc.), and/or the like. The wireless communication interface 730 may permit data to be exchanged with a network, wireless access points, other computer systems, and/or any other electronic devices described herein, such as the data communication network 130 and/or other networks described in relation to FIG. 1A. The communication can be carried out via one or more wireless communication antenna(s) 732 that send and/or receive wireless signals 734.

Depending on desired functionality, the wireless communication interface 730 can include separate transceivers to communicate with base transceiver stations and other wireless devices and access points, which may include communicating with different data networks and/or network types. A wireless wide-area network (WWAN), for example, may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, and so on. LTE, LTE Advanced, GSM, and W-CDMA are described in documents from 3rd Generation Partnership Project (3GPP). Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

The wireless device 700 can further include sensor(s) 740. Such sensors can include, without limitation, one or more accelerometer(s), gyroscope(s), camera(s), magnetometer(s), altimeter(s), microphone(s), proximity sensor(s), light sensor(s), and the like. Some or all of the sensor(s) 740 can be utilized, among other things, for dead reckoning and/or other positioning methods, which may be used in conjunction with techniques provided herein for the provisioning of the wireless device 700 and/or other devices in a network.

Embodiments of the mobile device may also include an SPS receiver 780 capable of receiving signals 784 from one or more SPS satellites using an SPS antenna 782. Such positioning can be utilized to complement and/or incorporate the techniques for calculating RTT described herein. The SPS receiver 780 can extract a position of the mobile device, using conventional techniques, from SPS SVs of an SPS system, such as Global Navigation Satellite System (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 780 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The wireless device 700 may further include and/or be in communication with a memory 760. The memory 760 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 760 of the wireless device 700 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above, including the methods described in FIGS. 5 and 6, might be implemented as code and/or instructions executable by the wireless device 700 (and/or a processing unit within a wireless device 700) (and/or another device of a positioning system). In an aspect, then, such code and/or instructions can be used to configure and/or adapt a general purpose computer (or other device) to perform one or more operations in accordance with the described methods.

FIG. 8 illustrates an embodiment of a computer system 800, which may be incorporated, at least in part, into devices such as the APs 120 of FIG. 1 and/or one or more computing devices incorporated and/or communicatively connected therewith, as described herein. Moreover, as previously indicated, devices such as APs can execute some or all of the methods for calculating RTT as described herein, including methods described in relation to FIGS. 3-6. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner. In addition, it can be noted that components illustrated by FIG. 8 can be localized to a single device and/or distributed among various networked devices, which may be disposed at different physical locations.

The computer system 800 is shown comprising hardware elements that can be electrically coupled via a bus 805 (or may otherwise be in communication, as appropriate). The hardware elements may include processing unit(s) 810, which can include without limitation one or more general-purpose processors, one or more special-purpose processors (such as digital signal processing chips, graphics acceleration processors, and/or the like), and/or other processing structure, which can be configured to perform one or more of the methods described herein, including the methods described in relation to FIGS. 3-6 and/or the functionality of the AP as shown in FIG. 1. The computer system 800 also can include one or more input devices 815, which can include without limitation a mouse, a keyboard, a camera, a microphone, other biometric sensors, and/or the like; and one or more output devices 820, which can include without limitation a display device, a printer, and/or the like.

Similar to the wireless device 700 of FIG. 7, the computer system 800 of FIG. 8 may include a clock 855 on the bus 805, which can generate a signal to synchronize the various components on the bus 805. The clock may be synchronized (or substantially synchronized) with corresponding clocks on other wireless devices to help increase the accuracy of RTT measurements while performing the techniques described herein. The clock 855 may be driven by the wireless communication interface 833, which may be used to synchronize the clock 855 of the computer system 800 to one or more other devices.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 800 might also include a communications subsystem 830, which can include wireless communication technologies managed and controlled by a wireless communication interface 833, as well as wired technologies. As such, the communications subsystem can include a modem, a network card (wireless or wired), an infrared communication device, a wireless communication device, and/or a chipset (such as a Bluetooth™ device, an IEEE 802.11 device, an IEEE 802.15.4 device, a WiFi device, a WiMax device, cellular communication facilities, UWB interface, etc.), and/or the like. The communications subsystem 830 may include one or more input and/or output communication interfaces, such as the wireless communication interface 833, to permit data to be exchanged with a network, mobile devices (such as the one or more STA(s) 105 of FIG. 1 or wireless device 700 of FIG. 7), other computer systems, and/or any other electronic devices described herein.

In many embodiments, the computer system 800 will further comprise a working memory 835, which can include a RAM or ROM device, as described above. Software elements, shown as being located within the working memory 835, can include an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above, such as the method described in relation to FIGS. 2-6 and/or the functionality of the AP(s) 120 as shown in FIG. 1, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 825 described above. In some cases, the storage medium might be incorporated within a computer system, such as computer system 800. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It can be noted that although the term “fine timing measurement frame” is used in the embodiments disclosed herein, the invention is not so limited. Embodiments may utilize frames having similar functionality, the description of which can vary depending on the technology, relevant standards, and/or other factors. Also, although embodiments herein are directed toward RTT measurement between two STAs, embodiments may involve other types of measurements and/or other types of devices.

Although embodiments disclosed herein have been generally described as being implemented as an apparatus or method, embodiments are not so limited. Embodiments may, for example, include computer-readable media and/or other means for performing the techniques described herein

An example system of calculating round trip time (RTT) from a first wireless device to a second wireless device, according to the disclosure, comprises means for sending, with the first wireless device, a first message, means for determining a first timestamp, indicative of the end of a period of time over which the first wireless device sent the first message, and means for receiving, with the first wireless device, a second message sent by the second wireless device in response to the first message. The system further comprises means for determining, with the first wireless device, a second timestamp, indicative of the end of a period of time over which the second wireless device received the first message, and a third timestamp, indicative of the beginning of a period of time over which the second wireless device sent the second message. The system also comprises means for determining a fourth timestamp, indicative of the beginning of a period of time over which the first wireless device received the second message, and means for determining the RTT from the first wireless device to the second wireless device, wherein determining the RTT is based, at least in part, on the first timestamp, the second timestamp, the third timestamp and the fourth timestamp.

The system can further comprise one or more of the following features. Means for determining the second timestamp and the third timestamp may comprise means for extracting the second timestamp and the third timestamp from the second message. Means for determining the second timestamp and the third timestamp may comprise means for extracting the second timestamp and the third timestamp from a third message, the third message received by the first wireless device and sent by the second wireless device in response to the first message. The system may further comprise means for receiving the third message in at least two parts, wherein the second timestamp is in one part of the third message and the third timestamp is in another part of the third message. The system may further comprise means for substantially synchronizing a clock of the first wireless device and a clock of the second wireless device. Sending the first message may be in response to a message sent from the second wireless device and received by the first wireless device.

According to the disclosure, an example computer-readable medium may comprise instructions embedded thereon for calculating round trip time (RTT) from a first wireless device to a second wireless device. The instructions may comprise computer code for sending, with the first wireless device, a first message, determining a first timestamp, indicative of the end of a period of time over which the first wireless device sent the first message, and receiving, with the first wireless device, a second message sent by the second wireless device in response to the first message. The instructions further comprises computer code for determining, with the first wireless device, a second timestamp, indicative of the end of a period of time over which the second wireless device received the first message, and a third timestamp, indicative of the beginning of a period of time over which the second wireless device sent the second message. The instructions also comprise computer code for determining a fourth timestamp, indicative of the beginning of a period of time over which the first wireless device received the second message, and determining the RTT from the first wireless device to the second wireless device, wherein determining the RTT is based, at least in part, on the first timestamp, the second timestamp, the third timestamp and the fourth timestamp.

The instructions can further comprise computer code for implementing one or more of the following features. Computer code for determining the second timestamp and the third timestamp may comprise computer code for extracting the second timestamp and the third timestamp from the second message. Computer code for determining the second timestamp and the third timestamp may comprise computer code for extracting the second timestamp and the third timestamp from a third message, the third message received by the first wireless device and sent by the second wireless device in response to the first message. The instructions may further comprise computer code for receiving the third message in at least two parts, wherein the second timestamp is in one part of the third message and the third timestamp is in another part of the third message. The instructions may further comprise computer code for substantially synchronizing a clock of the first wireless device and a clock of the second wireless device. Sending the first message may be in response to a message sent from the second wireless device and received by the first wireless device.

Another example system of calculating round trip time (RTT) from a first wireless device to a second wireless device, according to the description, comprises means for receiving, with the second wireless device from the first wireless device, a first message, means for sending, with the second wireless device to the first wireless device, a second message in response to the first message, and means for determining a first timestamp, indicative of the end of a period of time over which the second wireless device received the first message and a second timestamp, indicative of the beginning of a period of time over which the second wireless device sent the second message. The system further comprises means for the first timestamp and the second timestamp to the first wireless device.

The system can include one or more of the following features. Means for communicating the first timestamp and the second timestamp to the first wireless device may comprise means for including the first timestamp and the second timestamp in the second message. Means for communicating the first timestamp and the second timestamp to the first wireless device may comprise means for including the first timestamp and the second timestamp in a third message, the third message sent to the first wireless device by the second wireless device in response to the first message. The system may include means for sending, with the second wireless device, the third message in at least two parts, wherein the first timestamp is in one part of the third message and the second timestamp is in another part of the third message.

According to the description, another example computer-readable medium may comprise instructions embedded thereon for calculating round trip time (RTT) from a first wireless device to a second wireless device example system of calculating round trip time (RTT) from a first wireless device to a second wireless device. The instructions comprise computer code for receiving, with the second wireless device from the first wireless device, a first message, sending, with the second wireless device to the first wireless device, a second message in response to the first message, and determining a first timestamp, indicative of the end of a period of time over which the second wireless device received the first message and a second timestamp, indicative of the beginning of a period of time over which the second wireless device sent the second message. The instructions further comprise computer code for the first timestamp and the second timestamp to the first wireless device.

The instructions can further include computer code for implementing one or more of the following features. Computer code for communicating the first timestamp and the second timestamp to the first wireless device may comprise computer code for including the first timestamp and the second timestamp in the second message. Computer code for communicating the first timestamp and the second timestamp to the first wireless device may comprise computer code for including the first timestamp and the second timestamp in a third message, the third message sent to the first wireless device by the second wireless device in response to the first message. The instructions may include computer code for sending, with the second wireless device, the third message in at least two parts, wherein the first timestamp is in one part of the third message and the second timestamp is in another part of the third message.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method of calculating round trip time (RTT) from a first wireless device to a second wireless device, the method comprising:
sending, with the first wireless device, a first message;
determining a first timestamp, indicative of an end of a period of time over which the first wireless device sent the first message;
receiving, with the first wireless device, a second message sent by the second wireless device in response to the first message;
determining, with the first wireless device:
a second timestamp, indicative of an end of a period of time over which the second wireless device received the first message, and
a third timestamp, indicative of a beginning of a period of time over which the second wireless device sent the second message;
determining a fourth timestamp, indicative of a beginning of a period of time over which the first wireless device received the second message; and
determining the RTT from the first wireless device to the second wireless device, wherein determining the RTT is based, at least in part, on the first timestamp, the second timestamp, the third timestamp and the fourth timestamp.

2. The method of claim 1, wherein determining the second timestamp and the third timestamp comprises extracting the second timestamp and the third timestamp from the second message.

3. The method of claim 1, wherein determining the second timestamp and the third timestamp comprises extracting the second timestamp and the third timestamp from a third message, the third message received by the first wireless device and sent by the second wireless device in response to the first message.

4. The method of claim 3, further comprising receiving the third message in at least two parts, wherein the second timestamp is in one part of the third message and the third timestamp is in another part of the third message.

5. The method of claim 1, further comprising substantially synchronizing a clock of the first wireless device and a clock of the second wireless device.

6. The method of claim 1, wherein sending the first message is in response to a message sent from the second wireless device and received by the first wireless device.

7. A wireless device comprising:
a memory;
a wireless communication interface configured to:
wirelessly send a first message to a second wireless device; and
wirelessly receive a second message sent by the second wireless device in response to the first message; and
a processing unit communicatively coupled with the memory and the wireless communication interface and configured to:
determine a first timestamp, indicative of an end of a period of time over which the wireless device sent the first message;
determine a second timestamp, indicative of an end of a period of time over which the second wireless device received the first message;
determine a third timestamp, indicative of a beginning of a period of time over which the second wireless device sent the second message;
determine a fourth timestamp, indicative of a beginning of a period of time over which the wireless device received the second message; and
determine round trip time (RTT) from the wireless device to the second wireless device, wherein determining the RTT is based, at least in part, on the first timestamp, the second timestamp, the third timestamp and the fourth timestamp.

8. The wireless device of claim 7, wherein the processing unit is configured to determine the second timestamp and the third timestamp by extracting the second timestamp and the third timestamp from the second message.

9. The wireless device of claim 7, wherein the processing unit is configured to determine the second timestamp and the third timestamp by extracting the second timestamp and the third timestamp from a third message, the third message received by the wireless device and sent by the second wireless device in response to the first message.

10. The wireless device of claim 7, further comprising a local clock, wherein the processing unit is further configured to substantially synchronize the local clock to a clock of the second wireless device.

11. The wireless device of claim 10, wherein the processing unit is configured to substantially synchronize the clock of the wireless device to the clock of the second wireless device prior to determining the RTT.

12. The wireless device of claim 7, wherein the processing unit is configured to send the first message to the second wireless device in response to receiving an earlier message from the second wireless device.

13. A method of calculating round trip time (RTT) from a first wireless device to a second wireless device, the method comprising:
receiving, with the second wireless device from the first wireless device, a first message;
sending, with the second wireless device to the first wireless device, a second message in response to the first message;
determining:
a first timestamp, indicative of an end of a period of time over which the second wireless device received the first message, and
a second timestamp, indicative of a beginning of a period of time over which the second wireless device sent the second message; and
communicating the first timestamp and the second timestamp to the first wireless device.

14. The method of claim 13, wherein communicating the first timestamp and the second timestamp to the first wireless device comprises including the first timestamp and the second timestamp in the second message.

15. The method of claim 13, wherein communicating the first timestamp and the second timestamp to the first wireless device comprises including the first timestamp and the second timestamp in a third message, the third message sent to the first wireless device by the second wireless device in response to the first message.

16. The method of claim 15, further comprising sending, with the second wireless device, the third message in at least two parts, wherein the first timestamp is in one part of the third message and the second timestamp is in another part of the third message.

17. A first wireless device comprising:
a memory;
a wireless communication interface configured to:
wirelessly receive a first message from a second wireless device; and
wirelessly send, to the second wireless device, a second message in response to the first message; and
a processing unit communicatively coupled with the wireless communication interface and configured to:
determine a first timestamp, indicative of an end of a period of time over which the first wireless device received the first message;
determine a second timestamp, indicative of a beginning of a period of time over which the first wireless device sent the second message; and
communicate, via the wireless communication interface, the first timestamp and the second timestamp to the second wireless device.

18. The first wireless device of claim 17, wherein the processing unit is configured to communicate the first timestamp and the second timestamp to the second wireless device by including the first timestamp and the second timestamp in the second message.

19. The first wireless device of claim 17, wherein the processing unit is configured to communicate the first timestamp and the second timestamp to the second wireless device by including the first timestamp and the second timestamp in a third message, the third message sent, via the wireless communication interface, to the second wireless device in response to the first message.

20. The first wireless device of claim 19, wherein the processing unit is further configured to send the third message in at least two parts, wherein the first timestamp is in one part of the third message and the second timestamp is in another part of the third message.
